(19) United States
(12) Patent Application Publication
(10) Pub. No.: US 2023/0318831 A1
(43) Pub. Date: Oct. 5, 2023

(54) SYSTEM AND METHOD OF AUTHENTICATION OF USERS OF COMMON REUSABLE COMPONENTS

(71) Applicant: YAHOO ASSETS LLC, Dulles, VA (US)

(72) Inventors: Ayyappan ARASU, Sunnyvale, CA (US); Marcel BECKER, San Francisco, CA (US); Madan Kumar EPURI, Toronto (CA); Weicheng PAN, Taiwan (TW); George Fletcher, Round Hill, VA (US)

(21) Appl. No.: 17/708,228

(22) Filed: Mar. 30, 2022

(51) Int. Cl. H04L 9/32

(52) U.S. Cl. CPC H04L 9/3213

(57) ABSTRACT

Disclosed are systems and methods that provide a framework that allows for novel user interactions with dynamic messages using common reusable components and further allows for authentication of the user to the sender of the message. According to an embodiment, the framework functions by providing a message including a common reusable component with a corresponding content. The common reusable component allows the user to interact with the content. In some embodiments, in response to an interaction of the user with the common reusable component, a request is generated to the sender of the message to provide additional content or to perform an action. In some embodiments, the request includes an access token, a third-party token, or both. In some embodiments, the third-party token is created based on a credential of the user.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE DISCLOSURE

The present disclosure relates generally to improving the performance of network-based content hosting and delivery by modifying the capabilities of and providing non-native functionality to devices, systems and/or platforms in a network through a novel and improved framework for delivering common reusable components through messages and authenticating a user interacting with the common reusable component to allow the user to perform an action.

### BACKGROUND

Typically, messages communicating brand information or product offerings rely on static content to convey the desired information. For example, a message from a brand advertising a product may contain images and text describing the product and provide a link for a user to follow and learn more about or purchase the product. Some techniques in the art have attempted to introduce dynamism into the messages by using algorithms that simulate dynamic content but only provide limited functionality. Emerging solutions, such as Accelerated Mobile Pages (AMP) technology for email, provide a starting point for including dynamic content on emails. Still, broad implementation of AMP by users is limited by the complexity of the technology and the level of expertise required, essentially requiring users to become expert programmers. Moreover, current AMP implementations lack fundamental user authentication capabilities that allow secure transactions to take place right in the message through the common reusable component.

### SUMMARY

This disclosure provides a novel framework that alleviates shortcomings in the art, and provides dynamic messages including common reusable components and mechanisms for authenticating a user using the common reusable components. According to an embodiment, the framework functions by providing a message including a common reusable component with corresponding content. The common reusable component allows the user to interact with the content. In some embodiments, in response to an interaction of the user with the common reusable component, a request is generated to the sender of the message to provide additional content or to perform an action. In some embodiments, the request includes an access token, a third-party token, or both. In some embodiments, the third-party token is created based on a credential of the user. In some embodiments, the request is sent to the sender or an affiliate of the sender, and the sender, in turn, responds with requested content or performs the requested action.

According to some embodiments, common reusable components abstract common user interactions by users for content providers. In some embodiments, as used herein, a content provider may be a brand or an advertiser. In some embodiments, reusable components can be embedded in content communicated by the content provider. In some embodiments, the common reusable components not only abstract the user interface but may also enable analytics capture, tracking and reporting to the content provider. As will be noted, such functionality may evolve into a marketplace for the brands to consume as service offering. Additionally, in some embodiments, the common reusable components can abstract out common error handling, design patterns, and best practices so content providers do not have to invest in building them from the ground up thereby increasing the return on investment (ROI) of targeted communications. As discussed in further detail below, in some embodiments, common reusable components can provide user credential validation, expiry handling and fallback handling. In some embodiments, common reusable components can include device specific handling and feature extensions. As noted above, in some embodiments, user identification and authentication may provide content providers services that can be leveraged by the common reusable components in terms of tracking and geo distribution of goods and services from the content providers.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 depicts a schematic diagram illustrating an example of a network within which the systems and methods disclosed herein could be implemented according to some embodiments of the present disclosure;

FIG. 2 depicts a schematic diagram illustrating an example of client device in accordance with some embodiments of the present disclosure;

FIG. 3 depicts a block diagram illustrating components of an exemplary system in accordance with embodiments of the present disclosure;

FIG. 4A illustrates a non-limiting example embodiment of a common reusable components according to some embodiments of the present disclosure;

FIG. 4B illustrates a non-limiting example embodiment of a common reusable components according to some embodiments of the present disclosure;

FIG. 5 illustrates an exemplary workflow according to some embodiments of the present disclosure;

FIG. 6 illustrates an exemplary workflow according to some embodiments of the present disclosure;

FIG. 7 illustrates an exemplary workflow according to some embodiments of the present disclosure; and

FIG. 8 illustrates a process for generating a request from a user according to some embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable, and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), or one or more wide area networks (WANs).

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router (WR) mesh, or 2nd, 3rd, 4^{th}, or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or consumer or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices.

As discussed herein, reference to an “advertisement” should be understood to include, but not be limited to, digital media content embodied as a media item that provides information provided by another user, service, third party, entity, and the like. Such digital ad content can include any type of known or to be known media renderable by a computing device, including, but not limited to, video, text, audio, images, and/or any other type of known or to be known multi-media item or object. In some embodiments, the digital ad content can be formatted as hyperlinked multi-media content that provides deep-linking features and/or capabilities. Therefore, while some content is referred to as an advertisement, it is still a digital media item that is renderable by a computing device, and such digital media item comprises content relaying promotional content provided by a network associated party.

The detailed description provided herein is not intended as an extensive or detailed discussion of known concepts, and as such, details that are known generally to those of ordinary skill in the relevant art may have been omitted or may be handled in summary fashion.

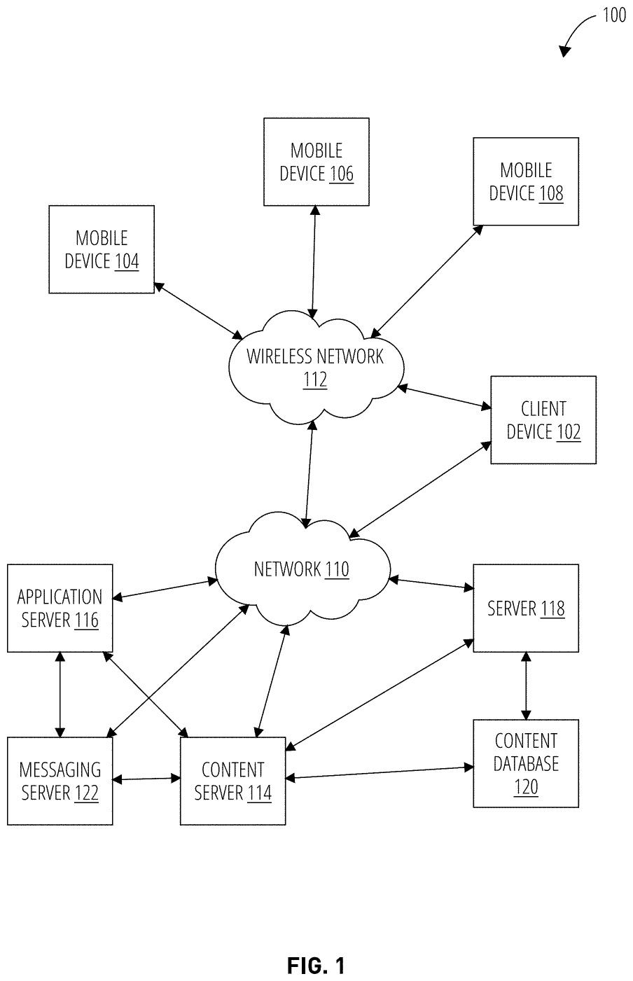

In general, with reference to FIG. 1, a system 100 in accordance with an embodiment of the present disclosure is shown. FIG. 1 shows components of a general environment in which the systems and methods discussed herein may be practiced. Not all the components may be required to practice the disclosure, and variations in the arrangement and type of the components may be made without departing from the spirit or scope of the disclosure. As shown, system 100 of FIG. 1 includes local area networks (“LANs”)/wide area networks (“WANs”)—network 110, wireless network 112, mobile devices (client device) 104-108 and client device 102. FIG. 1 additionally includes a variety of servers, such as content server 114, application (“App”) server 116 and third-party servers 118.

One embodiment of mobile devices 104-108 is described in more detail below. Generally, however, mobile devices 104-108 may include virtually any portable computing device capable of receiving and sending a message over a network, such as network 110, wireless network 112, or the like. Mobile devices 104-108 may also be described generally as client devices that are configured to be portable.

Mobile devices 104-108 also may include at least one client application that is configured to receive content from another computing device. The client application may include a capability to provide and receive textual content, graphical content, audio content, and the like. The client application may further provide information that identifies itself, including a type, capability, name, and the like. In one embodiment, mobile devices 104-108 may uniquely identify themselves through any of a variety of mechanisms, including a phone number, Mobile Identification Number (MIN), an electronic serial number (ESN), or other mobile device identifier.

In some embodiments, mobile devices 104-108 may also communicate with non-mobile client device, such as client device 102, or the like. Client device 102 may include virtually any computing device capable of communicating over a network to send and receive information.

Devices 102-108 may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Wireless network 112 is configured to couple mobile devices 104-108 and its components with network 110. Wireless network 112 may include any of a variety of wireless sub-networks that may further overlay stand-alone ad-hoc networks, and the like, to provide an infrastructure-oriented connection for mobile devices 104-108. Such sub networks may include mesh networks, Wireless LAN (WLAN) networks, cellular networks, and the like.

Network 110 is configured to couple content server 114, App server 116, or the like, with other computing devices, including, client device 102, and through wireless network 112 to mobile devices 104-108. Network 110 is enabled to employ any form of computer readable media or network for communicating information from one electronic device to another. Also, network 110 can include the Internet in addition to local area networks (LANs), wide area networks (WANs), or direct connections.

In some embodiments, the disclosed networks 110 and/or 112 may comprise a content distribution network(s). A “content delivery network” or “content distribution network” (CDN) generally refers to a distributed content delivery system that comprises a collection of computers or computing devices linked by a network or networks.

The content server 114 may include a device that includes a configuration to provide any type or form of content via a network to another device. Devices that may operate as content server 114 include personal computers, desktop computers, multiprocessor systems, microprocessor-based or programmable consumer electronics, network PCs, servers, and the like. Content server 114 can further provide a variety of services that include, but are not limited to, email services, instant messaging (IM) services, streaming and/or downloading media services, search services, photo services, web services, social networking services, news services, third-party services, audio services, video services, SMS services, MMS services, FTP services, voice over IP (VOIP) services, or the like. Such services, for example a video application and/or video platform, can be provided via the App server 116, whereby a user is able to utilize such service upon the user being authenticated, verified, or identified by the service. Examples of content may include images, text, audio, video, or the like, which may be processed in the form of physical signals, such as electrical signals, for example, or may be stored in memory, as physical states, for example.

In some embodiments, content server 114 may also be an ad server that provides distribution of online advertisements or product inventory for content providers where hosting services are provided in-house. In some embodiments, content Server 114 is not limited to online use cases but can include offline computing capabilities based on user signals to derive and personalize the right content at the right time for the user. In some embodiments, systems described herein can run either on-premise or supported by on cloud providers with proper handling of user opt-out signals. According to some embodiments, all data processing as described herein may use encryption at rest and transit and may include checks and auditing and monitoring of data access.

Third party server 118 (in some embodiments, an “ad server”) can comprise a server that stores online advertisements for presentation to users. “Ad serving” refers to methods used to place online advertisements on websites, in applications, or other places where users are more likely to see them, such as during an online session or during computing platform use, for example. Various monetization techniques or models may be used in connection with sponsored advertising, including advertising associated with the users. Such sponsored advertising includes monetization techniques including sponsored search advertising, non-sponsored search advertising, guaranteed and non-guaranteed delivery advertising, ad networks/exchanges, ad targeting, ad serving and ad analytics. Such systems can incorporate near instantaneous auctions of ad placement opportunities during web page creation, (in some cases in less than 500 milliseconds) with higher quality ad placement opportunities resulting in higher revenues per ad. That is, advertisers will pay higher advertising rates when they believe their ads are being placed in or along with highly relevant content that is being presented to users. Reductions in the time needed to quantify a high-quality ad placement offers ad platforms competitive advantages. Thus, higher speeds and more relevant context detection improve these technological fields.

For example, a process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en-masse to advertisers. For web portals like Yahoo!®, advertisements may be displayed on web pages or in apps resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users. One approach to presenting targeted advertisements includes employing demographic characteristics (e.g., age, income, gender, occupation, and the like) for predicting user behavior, such as by group. Advertisements may be presented to users in a targeted audience based at least in part upon predicted user behavior(s).

Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users. During presentation of advertisements, a presentation system may collect descriptive content about types of advertisements presented to users. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

Servers 114, 116, and 118 may be capable of sending or receiving signals, such as via a wired or wireless network, or may be capable of processing or storing signals, such as in memory as physical memory states. Devices capable of operating as a server may include, as examples, dedicated rack-mounted servers, desktop computers, laptop computers, set top boxes, integrated devices combining various features, such as two or more features of the foregoing devices, or the like. According to some embodiments, signals and data, as described herein, may be encrypted at both transit and rest to safeguard a user's privacy.

In some embodiments, users are able to access services provided by servers 114, 116, and/or 118. This may include in a non-limiting example, authentication servers, search servers, email servers, social networking services servers, SMS servers, IM servers, MMS servers, exchange servers, photo-sharing services servers, and travel services servers, via the network 110 and/or wireless network 112 using their various devices 102-108.

In some embodiments, applications, such as, but not limited to, news applications (e.g., Yahoo! Sports®, ESPN®, Huffington Post®, CNN®, and the like), mail applications (e.g., Yahoo! Mail®, Gmail®, and the like), streaming video applications (e.g., YouTube®, Netflix®, Hulu®, iTunes®, Amazon Prime®, HBO Go®, and the like), instant messaging applications, blog, photo or social networking applications (e.g., Facebook®, Twitter®, Instagram®, and the like), search applications (e.g., Yahoo!® Search), and the like, can be hosted by the App server 116, or content server 114 and the like.

Thus, the App server 116, for example, can store various types of applications and application related information including application data and user profile information (e.g., identifying and behavioral information associated with a user). It should also be understood that content server 114 can also store various types of data related to the content and services provided by content server 114 in an associated content database 120, as discussed in more detail below. Embodiments exist where the network 110 is also coupled with/connected to a Trusted Search Server (TSS) which can be utilized to render content in accordance with the embodiments discussed herein. Embodiments exist where the TSS functionality can be embodied within servers 114, 116, and/or 118.

Moreover, although FIG. 1 illustrates servers 114, 116, and 118 as single computing devices, respectively, the disclosure is not so limited. For example, one or more functions of servers 114, 116, and/or 118 may be distributed across one or more distinct computing devices. Moreover, in one embodiment, servers 114, 116, and/or 118 may be integrated into a single computing device, without departing from the scope of the present disclosure.

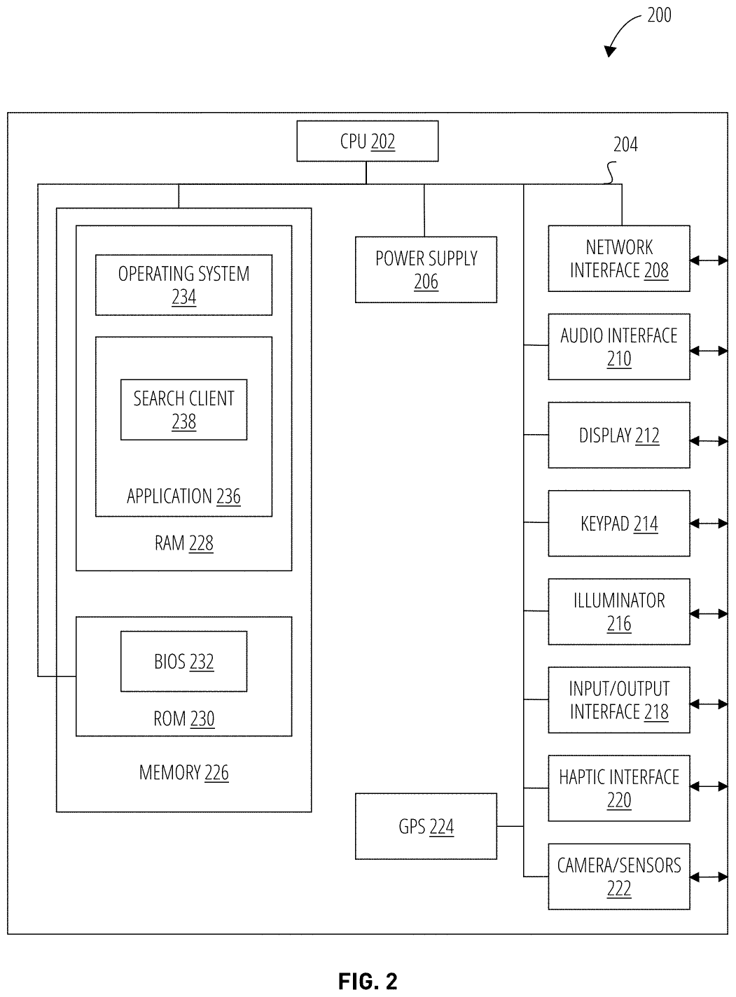

FIG. 2 is a schematic diagram illustrating an example embodiment of a device 200 (e.g., a client device) that may be used within the present disclosure. device 200 may include many more or less components than those shown in FIG. 2. However, the components shown are sufficient to disclose an illustrative embodiment for implementing the present disclosure. Device 200 may represent, for example, devices 118, 114, and/or 116 discussed above in relation to FIG. 1.

As shown in the figure, device 200 includes a processing unit (CPU) 202 in communication with a mass memory 226 via a bus 204. Device 200 also includes a power supply 206, one or more network interface 208, an audio interface 210, a display 212, a keypad 214, an illuminator 216, an input/output interface 218, a haptic interface 220, an optional global positioning systems (GPS) receiver 224 and a camera(s) or other optical, thermal, or electromagnetic sensor 222. Device 200 can include one camera/sensor 222, or a plurality of cameras/sensors 222, as understood by those of skill in the art. Power supply 206 provides power to device 200.

Device 200 may optionally communicate with a base station (not shown), or directly with another computing device. Network interface 208 is sometimes known as a transceiver, transceiving device, or network interface card (NIC).

Audio interface 210 is arranged to produce and receive audio signals such as the sound of a human voice. Display 212 may be a liquid crystal display (LCD), gas plasma, light emitting diode (LED), or any other type of display used with a computing device. Display 212 may also include a touch sensitive screen arranged to receive input from an object such as a stylus or a digit from a human hand.

Keypad 214 may comprise any input device arranged to receive input from a user. Illuminator 216 may provide a status indication and/or provide light.

Device 200 also comprise input/output interface 218 for communicating with external. Input/output interface 218 can utilize one or more communication technologies, such as USB, infrared, Bluetooth™, or the like. Haptic interface 220 is arranged to provide tactile feedback to a user of the device.

Optional GPS transceiver 224 can determine the physical coordinates of device 200 on the surface of the Earth, which typically outputs a location as latitude and longitude values.

Mass memory 226 includes a random-access memory (RAM) 228, a read-only memory (ROM) 230, and other storage means. Mass memory 226 illustrates another example of computer storage media for storage of information such as computer readable instructions, data structures, program modules or other data.

Mass memory 226 further includes one or more data stores, which can be utilized by device 200 to store, among other things, applications 236 and/or other information or data. For example, data stores may be employed to store information that describes various capabilities of device 200.

Applications 236 may include computer executable instructions which, when executed by device 200, transmit, receive, and/or otherwise process audio, video, images, and enable telecommunication with a server and/or another user of another client device. Applications 236 may further include search client 238 that is configured to send, to receive, and/or to otherwise process a search query and/or search result.

Having described the components of the general architecture employed within the disclosed systems and methods, the components' general operation with respect to the disclosed systems and methods will now be described below.

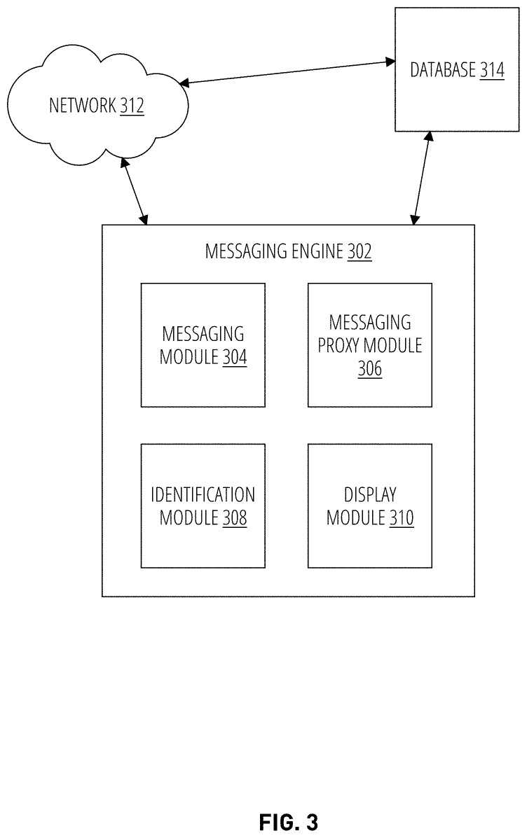

FIG. 3 is a block diagram illustrating the components for performing the systems and methods discussed herein. FIG. 3 includes messaging engine 302, network 312, and database 314. The messaging engine 302 can be a special purpose machine or processor and could be hosted by a cloud server (e.g., cloud web services server(s)), messaging server, application server, content server, social networking server, web server, search server, content provider, third party server, user's computing device, and the like, or any combination thereof.

According to some embodiments, messaging engine 302 can be a stand-alone application that executes on a user device. In some embodiments, messaging engine 302 can function as an application installed on the user's device, and in some embodiments, such application can be a web-based application accessed by the user device over a network. In some embodiments, portions of the messaging engine 302 function as an application installed on the user's device and some other portions can be cloud-based or web-based applications accessed by the user's device over a network, where the several portions of the messaging engine 302 exchange information over the network. In some embodiments, the messaging engine 302 can be installed as an augmenting script, program, or application (e.g., a plug-in or extension) to another application or portable data structure.

The database 314 can be any type of database or memory, and can be associated with a content server on a network (e.g., content server, a search server or application server) or a user's device (e.g., client device 102-108 or device 200 from FIG. 1 and FIG. 2, respectively). In some embodiments, database 314 includes a dataset of data and metadata associated with local and/or network information related to users, services, applications, content, and the like.

In some embodiments, such information can be stored and indexed in the database 314 independently and/or as a linked or associated dataset. As discussed above, it should be understood that the data (and metadata) in the database 314 can be any type of information and type, whether known or to be known, without departing from the scope of the present disclosure.

According to some embodiments, database 314 can store data for users, e.g., user data. According to some embodiments, the stored user data can include, but is not limited to, information associated with a user's profile, user interests, user behavioral information, user patterns, user attributes, user preferences or settings, user messages, user demographic information, user location information, user biographic information, and the like, or some combination thereof. In some embodiments, the user data can also include user device information, including, but not limited to, device identifying information, device capability information, voice/data carrier information, Internet Protocol (IP) address, applications installed or capable of being installed or executed on such device, and/or any, or some combination thereof. It should be understood that the data (and metadata) in the database 314 can be any type of information related to a user, content, a device, an application, a service provider, a content provider, whether known or to be known, without departing from the scope of the present disclosure.

According to some embodiments, database 314 can store data and metadata associated with users, messages, images, videos, text, products, items, and services from an assortment of media, applications and/or service providers and/or platforms, and the like. Accordingly, any other type of known or to be known attribute or feature associated with a message, data item, media item, login, logout, website, application, communication (e.g., a message) and/or its transmission over a network, a user and/or content included therein, or some combination thereof, can be saved as part of the data/metadata in datas tore 314.

As discussed above, with reference to FIG. 1, the network 312 can be any type of network such as, but not limited to, a wireless network, a local area network (LAN), wide area network (WAN), the Internet, or a combination thereof. The network 312 facilitates connectivity of the messaging engine 302, and the database 314 of stored resources. Indeed, as illustrated in FIG. 3, the messaging engine 302 and database 314 can be directly connected by any known or to be known method of connecting and/or enabling communication between such devices and resources. As noted elsewhere herein, not all the components may be required to practice the disclosure, and variations in the arrangement and type of the components may be made without departing from the spirit or scope of the disclosure. For example, in some embodiments, messaging engine 302 can function without the presence of network 312.

The principal processor, server, or combination of devices that comprise hardware programmed in accordance with the special purpose functions herein is referred to for convenience as messaging engine 302, and includes messaging module 304, messaging proxy module 306, identification module 308, and display module 310. It should be understood that the engine(s) and modules discussed herein are non-exhaustive, as additional or fewer engines and/or modules (or sub-modules) may be applicable to the embodiments of the systems and methods discussed. The operations, configurations and functionalities of each module, and their role within embodiments of the present disclosure will be discussed below.

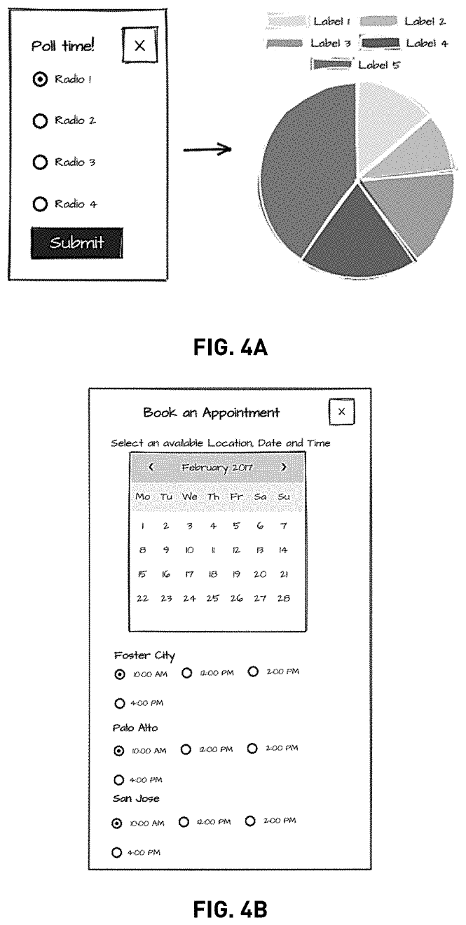

FIG. 4A and FIG. 4B illustrate non-limiting examples of common reusable components according to some embodiments of the present disclosure. According to some embodiments, a CRCs can be general purpose or use-specific widgets, modules, components, or pieces of code that may be embedded or included in a message. For example, in some embodiments, a content provider (e.g., a brand that wishes to advertise a product to a user through a message) may include a CRC including an advertisement for the product and functionality to purchase the product (e.g., add to cart and/or provide payment). FIG. 4A illustrates a poll module, while FIG. 4B illustrates a scheduling module. As noted above, common reusable components provide a collection of services along with the user interface. For example, in some embodiments, common reusable components may provide analytics, error handling, tracking, reporting and metrics collection, user token validation and fallback handling on expiry or invalid.

In some embodiments, a CRC may be an “add to cart” module, an email survey module, a feedback module, a shipping and tracking module, a product return module, a subscribe/unsubscribe module, an appointment module, and a product poll or ratings module. In some embodiments, the CRCs may be placed in pre-configured layouts for content creators to use in their messages. For example, in some embodiments, a message template directed to advertising a product may include CRCs for browsing products or checking out. In some embodiments, single click purchase of goods and services may be enabled for certain content providers. In those embodiments, the content providers may be provided with information necessary to enable the user to complete a transaction. For example, in some embodiments, the content provider may be provided with the payment method. In some embodiments, the content providers may be provided with user shipping/billing information without disclosing personally identifiable information (PII) of the user over a network to enable the user to complete the transaction. In some embodiments, CRS may for the tracking of goods and services post purchase.

According to some embodiments, common reusable components as described herein may be implemented, in part or as a whole, using Accelerated Mobile Pages (AMP). As will be noted AMP is an open-source Hypertext Markup Language (HTML) framework (a programming language) used typically in the development and implementation of web-based content. As used herein, according to some embodiments, AMP is used to create and implement CRCs on messages and webpages. In some embodiments, AMP provides dynamism for the CRC.

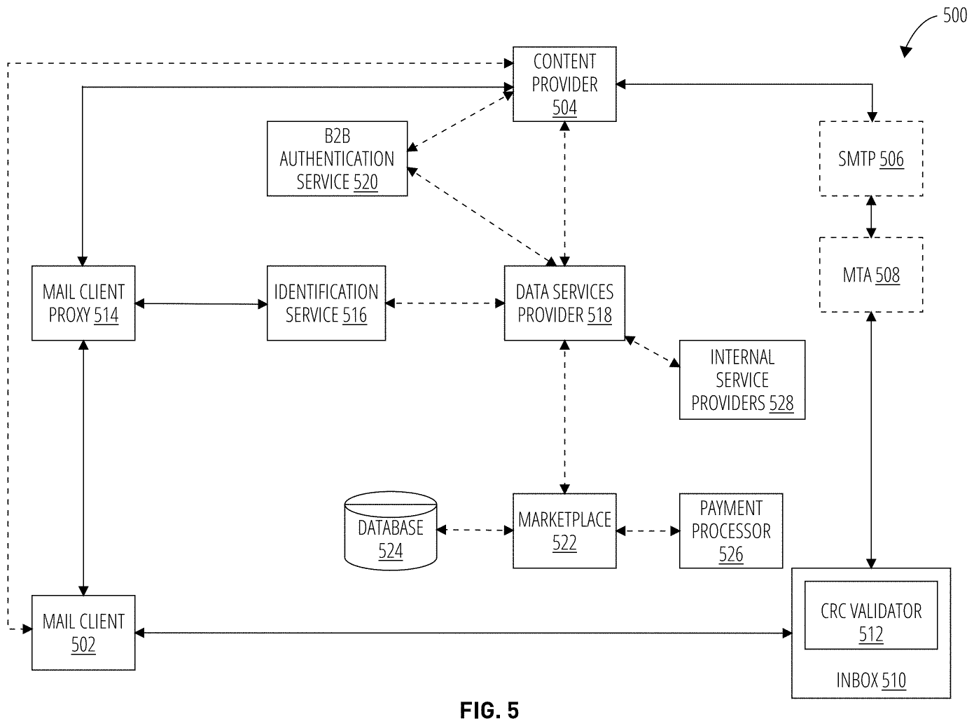

Turning now to FIG. 5, FIG. 5 depicts a non-limiting example embodiment of a framework 500 for authenticating a known user of a messaging system for interaction with common reusable components (CRC) in received messages.

According to an embodiment, a user receives and interacts with messages including common reusable components through mail client 502 (e.g., Yahoo!®, Gmail®), where the messages are generated and sent by and from content provider 504. As will be noted, a mail client 502 is an application that allows a user to read, send, and interact with messages (e.g., email or instant messaging application). In some embodiments, mail client 502 may be a desktop application, a web-based portal access through a browser, or a mobile application.

According to some embodiments, a message including common reusable components is generated by a content provider 504. In some embodiments, content provider 504 may be an Email Service Provider (ESP). In some embodiments, content provider 504 may be referred to as an AMP partner. Generally, messages with non-dynamic content are sometimes referred to as static messages, while messages with dynamic content are referred to as dynamic messages. As will be noted, traditional ESPs only provide static emails; that is, they generate the email but provide no further support. However, as noted above, a content provider 504 may be an ESP or an AMP partner that not only generates and sends a dynamic message but also hosts content to support interactions between the user and the common reusable components included in the message. Still, in some embodiments, while the content provider 504 may generate the message, the content or data associated with the content may be hosted in data services provider 518 as described below. According to some embodiments, dynamic messages may include CRCs using AMP elements (e.g., amp-list and amp-form) with XML HTTP Request (XHR) Uniform Resource Locator (URL) links for fetching remote json content and submitting forms. As discussed below, the XHR URLs may include time-limited access tokens. In some embodiments, the XHR URLs may include encrypted time-limited tokens.

In some embodiments, the common reusable component may include an access token. In some embodiments, the access token is user based and/or user specific. In some embodiments, the access token may be used in conjunction with a device identifier, as described below. In some embodiments, the access token is generated by the content provider 504. In some embodiments, access tokens may be time limited. In some embodiments, access tokens may not be time limited. In some embodiments, the access tokens have a time limit in terms of minutes, days, weeks, or months (e.g., 1 minute, 2 weeks, 30 days, 3 months). In some embodiments, the access tokens are embedded in a URL associated with the common reusable component. In some embodiments, the access tokens are embedded in a URL corresponding to content with the common reusable component.

Once the email is generated the content provider 504 sends the message to the user. In some embodiments, where the message is an email, the message may be sent using Simple Mail Transfer Protocol (SMTP) 506 and pass through a Message Transfer Agent (MTA) 508. In some embodiments, the MTA 508 may have a list to allow or deny messages with common reusable components from specific content providers 504 or to specific users. While the SMTP 506 and the MTA 508 can be email specific, it will be noted that similar functionality may be achieved using other protocols and agents. For example, in an embodiment, where the message is an instant message (IM) in a messaging platform (e.g., Instagram® or Snapchat®), the messaging platform may filter messages with CRCs from specific users or to specific users.

The message is then delivered to inbox 510. In some embodiments, inbox 510 may be an inbox of a user. In some embodiments, the inbox 510 may be located in the messaging server 122. In some embodiments, the inbox 510 may include a CRC validator 512. In some embodiments, the message is analyzed by the CRC validator 512 to validate a URL (e.g., an AMP XHR URL) associated with the CRC. In some embodiments, validating the CRC includes checking that a URL has a correct form and, thus, could be potentially legitimate. In some embodiments, validating a URL involves pinging a destination of the URL and determining if the destination is legitimate. In some embodiments, validating the CRC includes checking a code of the CRC. In some embodiments, validating the CRC includes checking and/or an AMP HTML code of the CRC. In some embodiments, validating the CRC includes authenticating a domain associated with the AMP XHR URL. In some embodiments, validating the CRC includes authenticating a sender associated with the AMP XHR URL. In some embodiments, based on the validation, an AMP message identifier is set which determines whether the user can get AMP functionality or not.

While the foregoing discusses the generation of the message, the following will discuss the interaction of the user with the message and the CRCs and authentication of the user to enable access to the functionality of the CRC.

According to an embodiment, a user may interact with the common reusable component contained in or within the message in the inbox 510 through mail client 502. In some embodiments, the user may interact with a CRC by selecting a field (e.g., a button, a checkbox, a dropdown list, a textbox, and the like). For example, in some embodiments, the message may be an advertising message including common reusable components displaying products (e.g., shoes, clothes, electronics). In those embodiments, the user may select a product and a size by clicking on the respective icons and then add the product to a cart within the common reusable component. In that sense, the user may shop, checkout, and pay entirely within the message through the common reusable component without having to use a different page or application to complete the transaction. In another example, in some embodiments, the message may include a request for the user to schedule a meeting or appointment and the common reusable component may provide scheduling functionality (e.g., to schedule a doctor's appointment or a business meeting). In those embodiments, the user may select or modify the desired date and time or some other parameter and finalize the appointment from the email without having to use a calendar application.

In some embodiments, when the user interacts with the CRC, the mail client 502 may send a request or instructions to the content provider 504. In some embodiments, the request or instructions may be an XHR call. In some embodiments, the request may be an AMP XHR call. In some embodiments, the mail client 502 may send a request to provide content (e.g., download images or text). In some embodiment, the mail client 502 may send information and/or instructions related to an action the content provider 504 may perform. For example, upon a selection or interaction of the user with a CRC in a message, the mail client 502 may send instructions to the content provider 504 to complete a transaction, provide payment, place an order, add product to cart, and schedule a meeting or appointment. In some embodiments, the request may include a URL. In some embodiments, the request may include an AMP URL.

In some embodiments, to authenticate the user and allow the request (or instructions) to be accepted by the content provider 504, the request may include identifiers corresponding to user credentials. In some embodiments, the identifier may be based on user credentials (e.g., user cookies, OAuth tokens, Device ID, biometrics, and the like). As will be noted, user cookies may be general purpose cookies used for website authentication. In some embodiments, user cookies may be time limited. In some embodiments, user cookies may not be time-limited and can be tracked easily across websites. In some embodiments, the request may include an access token as described above. In some embodiments, the request may include a device identification or identifier “ID” (e.g., mac address, IMEI). In some embodiments, the user is authenticated on the device (e.g., a user device) by using device specific identifiers being used to submit the request.

As will be understood by those skilled in the art, user credentials are not limited to prevalent standard world wide web techniques but may also include any known or to be known identification credentials without departing from the scope of the present disclosure. For example, in some embodiments, user credentials may include any known or to be known device identifier. As another example, in some embodiments, user credentials may include any known or to be known biometric markers capable of being used for authentication and authorization of a user.

In some embodiments, the request is passed to mail client proxy 514. In some embodiments, the mail client proxy 514 determines whether the request can go to the intended content provider 504. In some embodiments, the mail client proxy 514 maintains an allow list with the allowed endpoints that follows an approval workflow process to decide where the request may be directed. In some embodiments, mail client proxy 514 updates the allow list periodically (e.g., every 30 minutes, every hour, every day, etc.).

In some embodiment, if the intended recipient of the request is allowed, the mail client proxy 514 requests a third-party token from the identification service 516 based on the identifiers discussed above (e.g., the user credentials). As will be understood, a third-party token may be sometimes referred to as a proxy user identifier. In some embodiments, the third-party token may be a proxy for the user credentials (e.g., cookies, device id, and the like).

In some embodiments, only identification service 516 may encode or decode the third-party token. In some embodiments, the mail client proxy 514 and the identification service 516 communicate using mutual authentication (e.g., mTLS). In some embodiments, the third-party token may be a JSON Web Encryption (JWE) token (JWT). In some embodiments, the third-party token is generated using a time limited public certificate. In some embodiments, the third-party token is time limited. In some embodiments, the public certificate is issued by the identification service 516. Then, in some embodiments, the identification service 516 sends the third-party token to the mail client proxy 514. Still, in some embodiments, the identification service 516 sends the third-party token to the data services provider 518.

As will be described in further detail below, in some embodiments, the content provider 504 communicates with the data services providers 518 by sending a service request to the data services provider 518. In those embodiments, the data services provider 518 passes the third-party token (originally generated by identification service 516) to other internal services and systems after it is received from content provider 504. As noted elsewhere, in some embodiments, the content provider 504 may be external trusted clients/partners to an organization. In some embodiments, the identification service 516 sends the third-party token to both the mail client proxy 514 and the data services provider 518.

In some embodiments, third party tokens are tokens that may be used to communicate with trusted external entities (e.g., content provider 504). In those embodiments, the trusted external entity (e.g., a client or partner) may use the third-party token to pass back to data services provider 518 as an authentication mechanism to authenticate the user. In some embodiments, the external entities may exchange the third-party tokens to get signals, advertisements, or product recommendations on behalf of or for the user. In turn, in some embodiments, the identification service 516 validates the third-party token thereby indicating that the request received by data services provider 518 is a valid authenticated request and not one generated by a malicious entity (e.g., a hacker) or a third-party token generated by the malicious entity. It will be noted, that in some embodiments, the time between the generating the third-party token by identification service 516 upon request by the mail client proxy 514 and validating the third-party token for the data services provider 518 may be in the order of seconds or milliseconds. In some embodiments, a successful validation generates a transaction token from identification services 516. In some embodiments, the transaction token may be used by other downstream services (e.g., marketplace 522 or internal services provider 528).

According to an embodiment, the mail client proxy 514 modifies or transforms the request from the mail client 502 to remove any unique identifiers (e.g., user identifiers and device identifiers) and generates a modified request. In some embodiments, the mail client proxy 514 the modified request may include the access token, the third-party token, or both. Then, the mail client proxy 514 sends the modified request to the content provider 504. In some embodiments, the mail client proxy 514 and the content provider 504 may communicate using Hypertext Transfer Protocol Secure (HTTPS). In some embodiments, may communicate using Hypertext Transfer Protocol Secure (HTTPS) and a Demonstration of Proof-of-Possession (DPoP) header. As will be noted, in some embodiments, the DPoP may be requested by the content provider 504 for additional security validation in transactions or payments.

According to an embodiment, upon receiving the modified request, the content provider 504 may respond directly to the modified request (e.g., transmit requested content or perform an action). In some embodiments, prior to responding to the modified request, the mail client 502 may authenticate the modified request by validating the access token included in the request.

According to an embodiment, in order to satisfy the modified request, content provider 504 may need to obtain specific services from a data services provider 518. In an embodiment, upon receiving the modified request, content provider 504 may obtain the additional services from the data services provider 518 by sending a service request to the data services provider 518. In some of those embodiments, the service request includes the third-party token, a B2B token (e.g., OAuth 2), or both.

In some embodiments, to obtain a B2B token, the content provider 504 sends a request to fetch the B2B token from a B2B authentication service 520. In some embodiments, the B2B token is a B2B OAuth2 token. In some embodiments, this process may be performed offline by the content provider 504 by requesting for a tightly scoped request token.

According to an embodiment, after receiving the service request, the data services provider 518 may validate the B2B token by sending a validation request including the B2B token to the B2B authentication service 520 and receiving confirmation from the B2B authentication service 520 that the B2B token is legitimate. In some embodiments, the content provider 504, the B2B authentication service 520, and the data services provider 518 may communicate with each other using HTTPS.

After authenticating the service request, the data services provider 518 may proceed to fulfill the request. As will be noted, fulfilling a service request may depend on the type of the request and the context in which the framework 500 is used. For example, according to an embodiment, the data services provider 518 may provide marketplace services to the content provider 504 (e.g., browse products, add to cart, one-click payment, express checkout, and the like) by communicating with a marketplace 522 that, in turn, may also communicate with database 524 (that stores e-commerce data) and a payment processor 526 (that takes in payment data and processes a payment). In some embodiments, the data services provider 518 may send a marketplace service request to the marketplace 522 to perform an action (e.g., an action requested by the mail client 502 from the content provider 504). In turn, the marketplace 522 may communicate with database 524 and payment processor 526 to perform the requested action. Once completed, in an embodiment, the marketplace 522 may send a confirmation response to confirm the action to the data services provider 518, who, in turn, may send the confirmation to the content provider 504 and the content provider 504 may send it to the mail client 502 and/or the mail client proxy 514. In some embodiments, communications between data services provider 518 and internal service providers 528 uses mTLS. In some embodiments, marketplace services (e.g., “add to cart services”) may use HTTPS. In some embodiments, marketplace services may be external marketplace services.

In those embodiments, the data services provider 518 may provide the third-party tokens to the identification service 516 to exchange the third-party tokens for transaction tokens to be used within the marketplace environment. In some embodiments, the transaction tokens may be JSON Web Signature (JWS) tokens. In some embodiments, transaction tokens are JWS tokens signed with a public-private key pair. In some embodiments, the private key is only accessible to the identification service 516. In some embodiments, transaction tokens are tokens that may be used within an organization only. In some embodiments, the public key is accessible to internal systems within an organization. In some embodiments, the internal services can verify the transaction tokens with the public key and, once they are verified a unique user identifier for the user can be extracted from the transaction tokens. In some embodiments, the unique user identifier is a globally unique user identifier. In some embodiments, using transaction tokens can alleviate the computation load that several internal systems incur in verifying traditional credentials.

In some embodiments, the data services provider 518 may use the transaction tokens to obtain other services from internal service providers 528.

According to some embodiments, elements 502, and 508-528, may form part of the same system, while elements 504 and 506 may be external elements to said system.

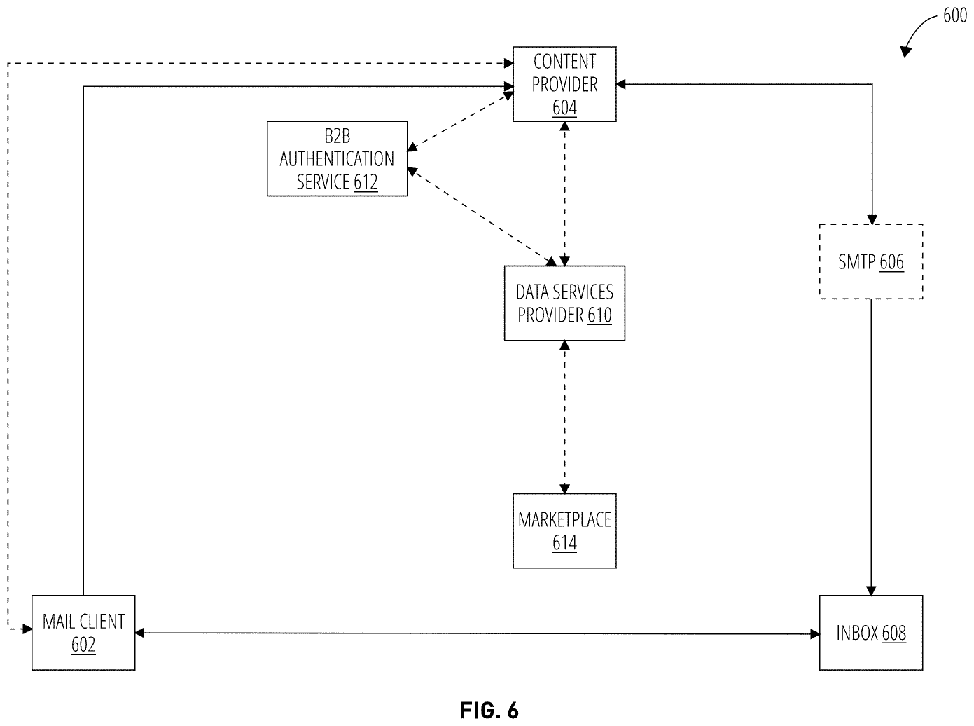

Turning now to FIG. 6, FIG. 6 depicts a non-limiting example embodiment of a framework 600 for authenticating a user of a messaging system for interaction with common reusable components (CRC) in received messages.

According to an embodiment, a content provider 604 generates and sends a dynamic message including an access token. In some embodiments, the message also includes a URL. In some embodiments, the URL is an AMP XHR URL. In some embodiments, the access token corresponds to the specific user. In some embodiments, the content provider 604 sends the dynamic message using SMTP 606.

According to an embodiment, the sent message is received by an inbox 608 related to the user. Then, the user may access the inbox 608 to view and interact with the message through a mail client 602. In some embodiments, the user interacts with a CRC included in the message (e.g., by providing an input). In response to the input received from the user, the mail client 602 may generate and send a request to the content provider 604. In some embodiments, the request is a request that the content provider 604 provide specific content or perform a given action. In some embodiments, the request may include the access token. In some embodiments, the request may include the URL. In some embodiments, the mail client 602 and the content provider 604 may communicate using Hypertext Transfer Protocol Secure (HTTPS).

According to an embodiment, upon receiving the request, the content provider 604 may respond directly to the modified request (e.g., transmit requested content or perform an action). In some embodiments, prior to responding to the modified request, the mail client 602 may authenticate the modified request by validating the access token included in the request. In some embodiments, the mail client 602 may also retrieve a message ID from the received request (e.g., the user's email address from the request header).

According to an embodiment, in order to satisfy the modified request, content provider 604 may need to obtain specific services from a data services provider 610. In an embodiment, upon receiving the modified request, content provider 604 may obtain the additional services from the data services provider 610 by sending a service request to the data services provider 610. In some of those embodiments, the service request includes the message ID, a B2B token, or both.

In some embodiments, to obtain a B2B token, the content provider 604 sends a request to fetch the B2B token from a B2B authentication service 612. In some embodiments, the B2B token is a B2B OAuth2 token.

According to an embodiment, after receiving the service request, the data services provider 610 may validate the B2B token by sending a validation request including the B2B token to the B2B authentication service 612 and receiving confirmation from the B2B authentication service 612 that the B2B token is legitimate. In some embodiments, the content provider 604, the B2B authentication service 612, and the data services provider 610 may communicate with each other using HTTPS.

After authenticating the service request, the data services provider 610 may proceed to fulfill the request. As will be noted, fulfilling a service request may depend on the type of the request and the context in which the framework 600 is used. For example, according to an embodiment, the data services provider 610 may provide marketplace services (e.g., browse products, add to cart, and the like) by communicating with marketplace 614. In some embodiments, the data services provider 610 communicates with the marketplace 614 using mTLS. In some embodiments, where marketplace 614 is an external marketplace, the data services provider 610 may communicate with the external marketplace (or “Add to Cart” service) using HTTPS. In some embodiments, the data services provider 610 may send the marketplace 614 a marketplace service request (e.g., fetch a product or “add to cart”). In some embodiments, the marketplace service request may include the message ID. For example, in some embodiments, the marketplace service request is a request to generate a checkout URL in response to an “add to cart” action. In response to receiving the marketplace service request, the marketplace 614 may respond with a cart URL. In some embodiments, the cart URL may then be passed to the content provider 604, and the content provider 604 may then send it to the mail client 602.

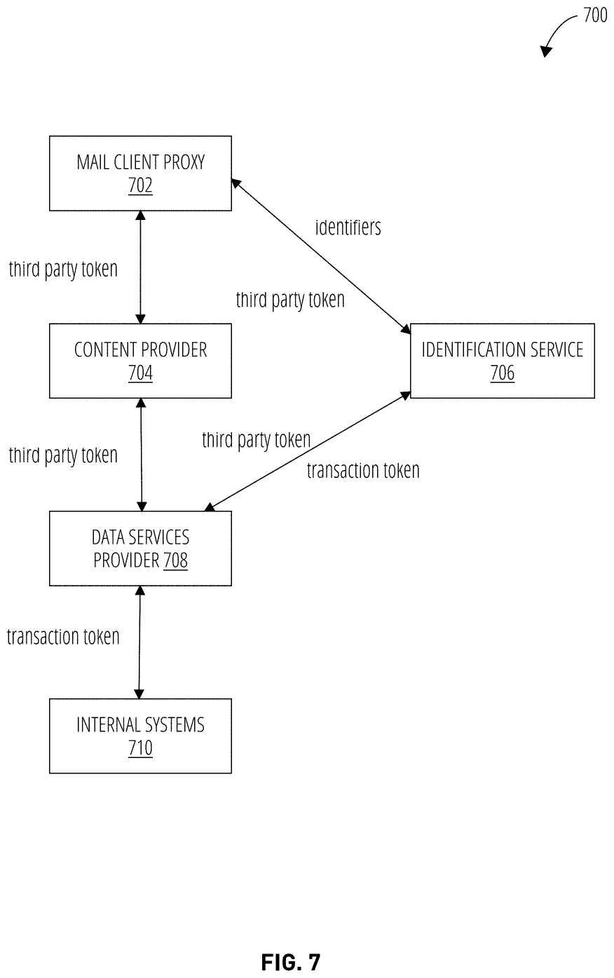

As will be noted by those skilled in the art, FIG. 7 depicts a non-limiting example embodiment of a simplified data flow 700 for exchanging and creating tokens, according to an embodiment. As noted above, in an embodiment, the mail client proxy 702 exchanges a set of identifiers or credentials (e.g., cookies) for a third-party token with the identification service 706.

Then, in an embodiment, the mail client proxy 702 uses the third-party token to authenticate a request to the content provider 704. To request services from the data services provider 708, in an embodiment, the content provider 704 transmits the third-party token to the data services provider 708.

In some embodiments, the data services provider 708 exchanges the third-party token for transaction tokens with the identification service 706 and uses the transaction tokens to request services from other internal systems 710 that may also use the transaction tokens to authenticate other internal service requests.

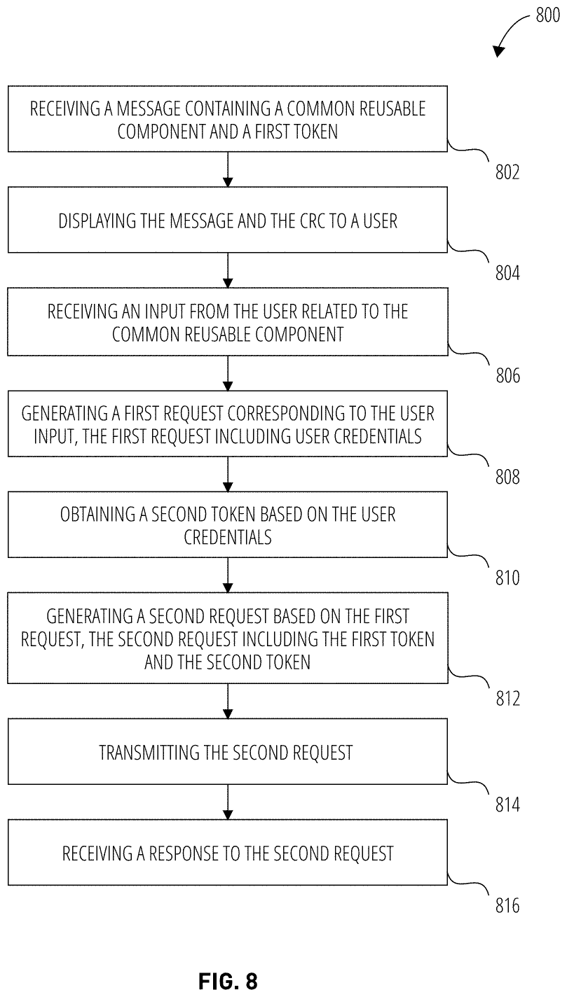

Turning to FIG. 8, Process 800 details non-limiting embodiments for generating a request from a user interacting with a common reusable component in a message. Process 800 begins with Step 802, where an incoming message containing CRCs sent by a sender (e.g., content provider 504) and addressed to an inbox (e.g., inbox 510) of a recipient user is received by a server (e.g., messaging server 122 or messaging module 304 of messaging engine 302). In some embodiments, the message may include a first token generated by the sender (e.g., an access token generated by the content provider 504).

In Step 804, the message with the CRCs is displayed to the user (e.g., with display module 310 and/or display 212). In turn, in Step 806, the user interacts with the CRCs and provides an input corresponding to the CRCs (e.g., through keypad 214 or input/output interface 218) and the messaging engine 302 receives the input. As noted elsewhere, the input may be a selection or interaction by the user with the CRC (e.g., to add a product to a cart, to checkout, to schedule an appointment, to provide a rating or feedback, and the like).

In response to receiving the input from the user, in Step 808, a first request is generated by the messaging module 304. In some embodiments, the first request may be a request to the sender, or an entity affiliated with the sender, to provide information or content (e.g., text or images), or to perform an action (e.g., schedule an appointment or complete a payment). In some embodiments, the first request may include a first token, user credentials, user or device identifiers, or a combination thereof. In some embodiments, the first request may be an internal request that may not be sent to external entities. In an embodiment, an external entity may be the content provider 504. In some embodiments, the first request may include a URL. In some embodiments, the first request may be an AMP XHR call. In some embodiments, the first request may include an AMP link.

Then, in Step 810, the messaging module 304 obtains a second token from the identification module 308. In some embodiments, the second token may be a third-party token as described herein. In some embodiments, the second token may be shared with external entities. In Step 812, the messaging module 304 generates a second request based on the first request. In some embodiments, generating the second request includes modifying the first request to remove any user credentials or other user or device identifiers that may be included in the first request. In some embodiments, generating the second request includes modifying the first request to include the second token. In some embodiments, the second request may include a URL. In some embodiments, the second request may be an AMP XHR call. In some embodiments, the second request may include an AMP link. In some embodiments, the second request may be identical to the first request except for the tokens included in the request.

In Step 814, the messaging engine 302 transmits the second request to the sender. In Step 816, the messaging engine 302 may receive a response from the sender or an affiliated entity. As noted elsewhere, the response may include information or content from the sender or an affiliated entity. For example, in an embodiment, the sender may provide an image corresponding to a product or a video corresponding to an advertisement. As another example, in an embodiment, the sender may reply with an acknowledgement that the request was received or that an action related to the second request was taken.

As utilized herein, the terms “comprises” and “comprising” are intended to be construed as being inclusive, not exclusive. As utilized herein, the terms “exemplary,” “example,” and “illustrative,” are intended to mean “serving as an example, instance, or illustration” and should not be construed as indicating, or not indicating, a preferred or advantageous configuration relative to other configurations. As utilized herein, the terms “about,” “generally,” and “approximately” are intended to cover variations that may existing in the upper and lower limits of the ranges of subjective or objective values, such as variations in properties, parameters, sizes, and dimensions. In one non-limiting example, the terms “about,” “generally,” and “approximately” mean at, or plus 10 percent or less, or minus 10 percent or less. In one non-limiting example, the terms “about,” “generally,” and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A method comprising:
receiving a message sent by a sender to a user, the message including a common reusable component and a first token associated with the user;
displaying the message and the common reusable component to the user;
receiving an input from the user corresponding to an interaction with the common reusable component;
generating a first request in response to the input from the user, the first request including user credentials;
obtaining a second token, the second token based on the user credentials;
generating a second request based on the first request, the second request including the second token;
transmitting the second request to the sender; and
receiving a response to the second request.

2. The method of claim 1, wherein the first token is an access token generated by the sender.

3. The method of claim 1, wherein the message further includes an AMP XHR URL, and the first request and the second request include the AMP XHR URL.

4. The method of claim 3, further comprising authenticating the AMP XHR URL.

5. The method of claim 1, wherein the second token is also based on a device identification of a device of the user.

6. The method of claim 1, where in the second token is a time limited third-party token encrypted using JSON Web Encryption (JWE).

7. The method of claim 1, wherein generating the second request based on the first request comprises removing the user credentials from the first request.

8. A non-transitory computer-readable storage medium, the computer-readable storage medium including instructions that when executed by a computing device, cause the computing device to:
receive a message sent by a sender to a user, the message including a common reusable component and a first token associated with the user;
display the message and the common reusable component to the user;
receive an input from the user corresponding to an interaction with the common reusable component;
generate a first request in response to the input from the user, the first request including user credentials;
obtain a second token, the second token based on the user credentials;
generate a second request based on the first request, the second request including the second token;
transmit the second request to the sender; and
receive a response to the second request.

9. The computer-readable storage medium of claim 8, wherein the first token is an access token generated by the sender.

10. The computer-readable storage medium of claim 8, wherein the message further includes an AMP XHR URL, and the first request and the second request include the AMP XHR URL.

11. The computer-readable storage medium of claim 10, wherein the instructions further configure the computing device to validate the AMP XHR URL.

12. The computer-readable storage medium of claim 8, wherein the second token is also based on a device identification of the computing device of the user.

13. The computer-readable storage medium of claim 8, where in the second token is a time limited third party token encrypted using JSON Web Encryption (JWE).

14. The computer-readable storage medium of claim 8, wherein the instructions further configure the computing device to generate the second request based on the first request by removing the user credentials from the first request.

15. A computing device comprising:
a processor configured to:
receive a message sent by a sender to a user, the message including a common reusable component and a first token associated with the user;
display the message and the common reusable component to the user;
receive an input from the user corresponding to an interaction with the common reusable component;
generate a first request in response to the input from the user, the first request including user credentials;
obtain a second token, the second token based on the user credentials;
generate a second request based on the first request, the second request including the second token;
transmit the second request to the sender; and
receive a response to the second request.

16. The computing device of claim 15, wherein the message further includes an AMP XHR URL, and the first request and the second request include the AMP XHR URL.

17. The computing device of claim 16, wherein the processor is further configured to validate the AMP XHR URL.

18. The computing device of claim 15, wherein the second token is also based on a device identification of the computing device of the user.

19. The computing device of claim 15, where in the second token is a time limited third party token encrypted using JSON Web Encryption (JWE).

20. The computing device of claim 15, wherein generating the second request based on the first request comprises removing the user credentials from the first request.
